(19) United States
(12) Patent Application Publication
(10) Pub. No.: US 2007/0136190 A1
(43) Pub. Date: Jun. 14, 2007

(54) Electronic service procurement and invoicing system

(76) Inventor: Chuck Engle, Pompano Beach, FL (US)

Correspondence Address: The Intellect Law Group, 2400 SE Federal Highway, Suite 340, Stuart, FL, 34994, US

(21) Appl. No.: 11/301,315

(22) Filed: Dec. 12, 2005

(51) Int. Cl. G06Q 40/00

(52) U.S. Cl. 705/40

(57) ABSTRACT

This invention relates to a system and method for creating a novel electronic service procurement and invoicing system.

### FIELD OF THE INVENTION

This invention relates to a system and method for creating a novel electronic service procurement and invoicing system.

### BACKGROUND OF THE INVENTION

Electronic service procurement and invoicing systems are well known in the prior art. The advent of computers has made electronic service procurement and invoicing systems an alternative to traditional typed or handwritten invoices and is often a preferred method of billing customers and tracking the sale of goods and services. Conventionally, electronic invoicing has been accomplished by inputting static data into fields that may be viewed and/or altered electronically. A major disadvantage to conventional electronic invoices is that the invoices do not have features that allow real-time invoice viewing while services are being performed. Further traditional electronic invoicing systems do not allow modifications to be made while the invoice is activated.

For example, U.S. Pat. No. 6,044,362 entitled “Electronic Invoicing and Payment System,” is an electronic invoicing system that allows customers to view an invoice electronically and accept the pre-entered, static billing data or modify the billing data to meet the customer's approval. In the cited invention, the invoice data is entered and complete before it is sent to the customer. The cited invention does not allow real-time viewing of the invoice as services are being performed and does not allow modifications to be made to the invoice before the work is completed.

Similarly, U.S. Pat. No. 6,282,552 entitled “Customizable Electronic Invoice with Optional Security” is related to customizing bills to allow users to designate whether certain monetary charges are personal or work-related and to save and share those charges with others to improve internal accounting procedures. The cited invention also does not allow real-time viewing of the invoice as services are being performed and does not allow modifications to be made to the invoice before the work is completed.

Lastly, U.S. Pat. No. 6,507,826 entitled “Remote Electronic Invoice entry and Validation System and Method Therefore,” relates to a method and apparatus for remotely and electronically entering invoices and validating the invoices in an invoice processing system. The cited invention however creates the invoice based on information entered into a computer from a corresponding invoice. The cited invention also does not allow real-time viewing of the invoice as services are being performed and does not allow modifications to be made to the invoice before the work is completed.

Procuring services electronically has traditionally been accomplished by compiling a database of service providers that are searched using variable criteria to locate a local service provider. Conventional electronic service procurement systems however do not have features that allow a customer to only choose from currently available service providers. This is a distinct disadvantage of prior art systems because customers can waste valuable time selecting and attempting to contact service providers who may be in the system but who are nonetheless unavailable due to numerous reasons, such as currently working at another site or on vacation.

For example, prior art U.S. Patent Application No. 2004/0220848 A1, entitled “System and Method for Managing Requests for Service,” is an electronic procurement system that populates a registry with a plurality of service providers for customers to chose from to service their work order requests. The registry is populated with service providers who have provided general static information regarding their days and hours of availability, which are inputted into the registry that customers select from. Although the service provider may change this information by updating their profile, the system does not provide for up-to-the-minute determinations as to actual availability nor does the system provide for a registry that customers can choose from that is limited to those service providers who are currently available to accept work orders.

Clearly there is a need for an electronic procurement system that is more efficient and saves time by providing customers with a constantly changing database of available service providers. Moreover, there is a need for an integrated invoicing system that allows for real-time viewing of the invoice as services are being performed and allows modifications to be made to the invoice before the work is completed.

### SUMMARY OF THE INVENTION

The present invention has numerous distinct advantages over the prior art. First, the electronic service procurement component of the present invention comprises a listing of available service providers that continuously updates the availability of those service providers based on whether the service providers are logged onto the system as available for work that day or whether those providers who are logged on are currently unavailable due to other jobs they are currently working on. This is a distinct advantage over the prior art because it assists in ensuring the client's time is not wasted on requesting service providers who are not available.

Opening an account can be performed easily online by visiting a website and entering the zip code, time zone, and type of incident to be fixed. Clients may choose local technicians who are available in the area. The client enters contact information and payment information. After payment has been confirmed, a request is placed for a third party tax rate provider to provide tax rates for labor and parts based upon the zip code entered to select the technician. These rates are then written to the database along with the incident details and are to be applied upon closing the invoice for calculating the taxes due and reflecting those taxes on the final invoice.

Another distinct advantage of the present invention is the electronic invoicing component that allows clients to view the invoice in real-time and make modifications to the invoice before the service is completed. The invoice has several unique and novel features that allow the client to view the invoice in real time from a remote location as the work is being performed. While services are being rendered a client may log onto the system and open the invoice in progress by providing a user name and password. The invoice will inform the client as to whether the service provider is present, working on the incident, how much time has been used and/or remains unused, the invoice total for parts and labor, and the service provider's contact information in the event the client wishes to contact the service provider. The client and technician also have the option of engaging in a real-time chat, which reflects the correspondence on the invoice.

If additional parts are necessary, the service provider may select and add additional parts from the online tech store to the invoice. Once the parts are added to the invoice by the service provider, an e-mail notification is sent to the client requesting that the client log onto the website using his or her user name and password and approve the purchase of additional parts. Once the client is logged onto the website, he or she will view the client invoice to approve the addition or parts and input additional payment information. The client invoice and the service provider invoice are not identical in all respects. In this instance, the client invoice will have payment options but the service provider's invoice will never show the client's payment methods to prevent fraud.

If the service provider encounters a problem and needs assistance, the service provider may pause the invoice so that the client is not charged while the service provider is requesting assistance from other available service providers. The invoice may also be paused and started for other reasons as well, such as taking a personal break. Another unique feature of the system allows the helping service provider to join on the invoice and share the fees for helping the service provider in need of assistance. In the preferred system, the client invoice will also reflect that a helping service provider has joined the service request to keep the client informed of the service status.

In addition to requesting approval for parts, the electronic invoice allows a service provider to request additional time to complete the service request. In the preferred system, the invoice would automatically be set at a minimum hourly charge for undertaking the service request, for example one hour. The invoice's real time timer would count down the hour until the hour is used or the service provider stops the timer. If it appears the request will take longer to complete, the service provider may select additional time to be added to the invoice. Similar to the addition of parts, an e-mail notification will be sent to the client requesting that the client log onto the website using his or her user name and password, open the invoice, approve the addition of time, and enter additional payment information. At anytime, if the client is already logged onto the website, he or she may simply refresh the browser to view the service provider's requested additions to the invoice. The service provider's invoice will update to show the client's approval of the additional time; however, the service provider's invoice will not reflect the client's payment information. The invoice may also include an option to add offsite time to the invoice. This feature is particularly useful in situations where fixing the incident is time-consuming and does not require the service provider's constant attention, such as scrubbing a computer and reinstalling software. This feature allows the client and service provider an opportunity to barter for a lower price or flat fee in exchange for allowing the service provider to take, for example, a computer offsite to complete at night and take other service requests during normal business hours. Similar to requesting additional parts and time, an e-mail notification will be sent to the client requesting that the client log onto the website using his or her user name and password, open the invoice, approve the addition of offsite time, and enter additional payment information.

### BRIEF DESCRIPTION OF THE DRAWINGS

FIG. 1 is a flowchart depicting the system and method utilized by a client to open an account by creating a partial invoice for services and requesting acceptance of the invoice from an available service provider.

FIG. 1A is a sample screen shot of a website showing a listing of available service providers.

FIG. 1B is a sample screen shot of a website showing how a service provider will check-in to inform the system of his or her availability for work.

FIG. 2 is a flowchart depicting the electronic invoicing system component.

FIG. 2A is a sample screen shot of a website showing a sample electronic invoice that is viewed by the technician.

FIG. 2B is a sample screen shot of a website showing a sample electronic invoice that is viewed by the client.

FIG. 2C is a sample screen shot of a website showing an online store where technicians can order parts necessary to complete the service request.

FIG. 2D is a sample screen shot of a website showing a client's invoice that is requesting the addition of parts to the invoice and providing payment methods to the client.

FIG. 2E is a sample screen shot of a website showing a technician's invoice that reflects the client has accepted and paid for additional parts.

FIG. 2F is a sample screen shot of a website depicting a technician's engagement of another technician to assist in completing the service request.

FIG. 2G is a sample screen shot of a website showing the technician's request for the addition of time to the invoice to complete the service request.

FIG. 2H is a sample screen shot of a website showing the client's approval and payment authorization of additional time to complete the service request.

FIG. 2I is a sample screen shot of a website showing the technician's request for the addition of off site time to the invoice to complete the service request.

FIG. 2J is a sample screen shot of a website showing the client's approval and payment authorization of additional off site time to complete the service request.

FIG. 2K is a sample screen shot of a website showing a real-time chat between a technician and a client reflected on the invoice.

### DETAILED DESCRIPTION OF THE DRAWINGS

The described drawings depict the system and method as applied to the computer repair industry; however, it is intended that the disclosed invention may also be applied to numerous other service industries and is not intended to be limited by the application of the invention to a particular industry in this description.

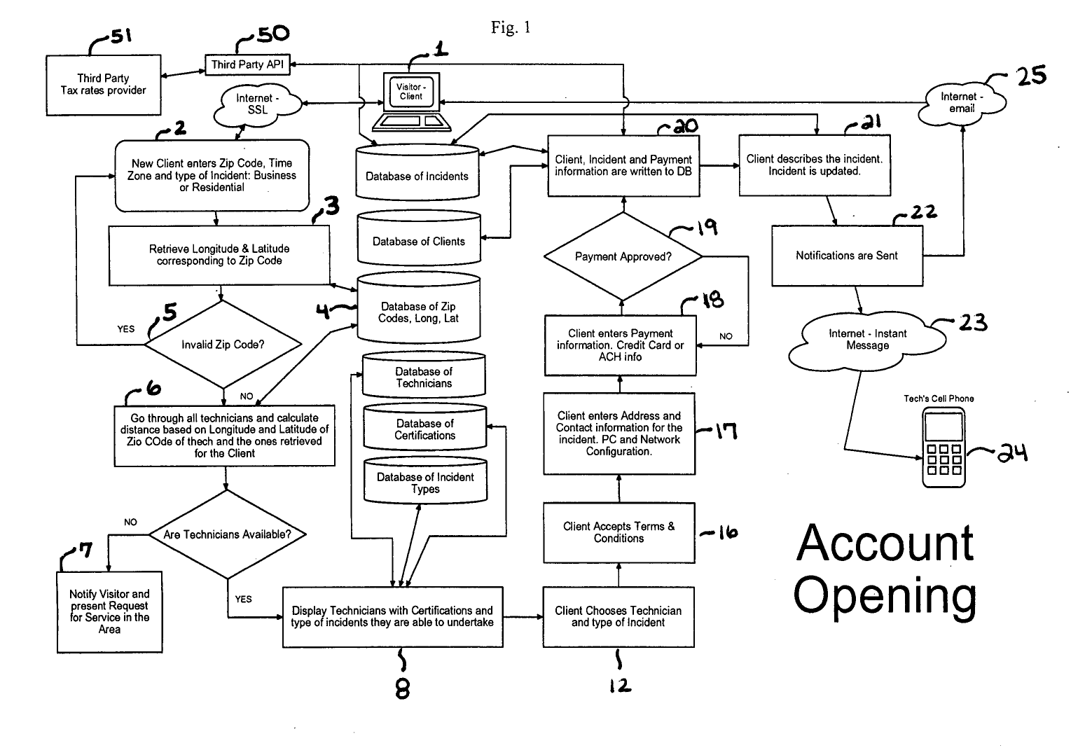

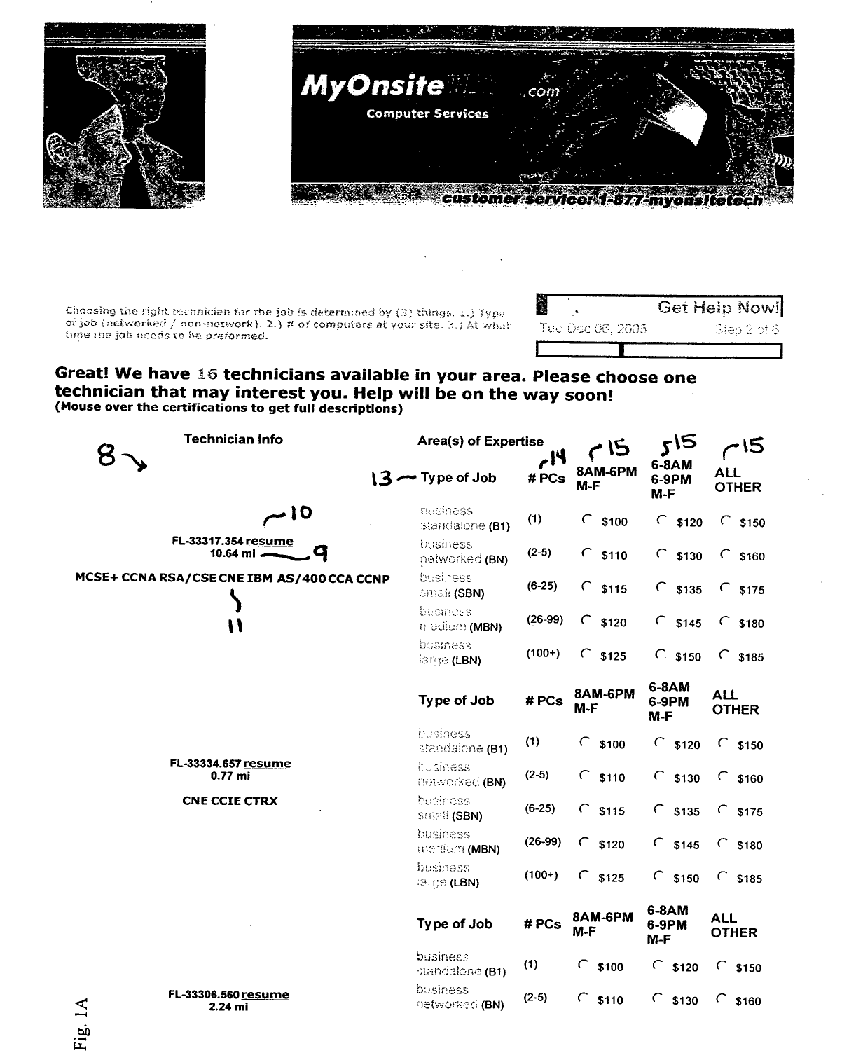

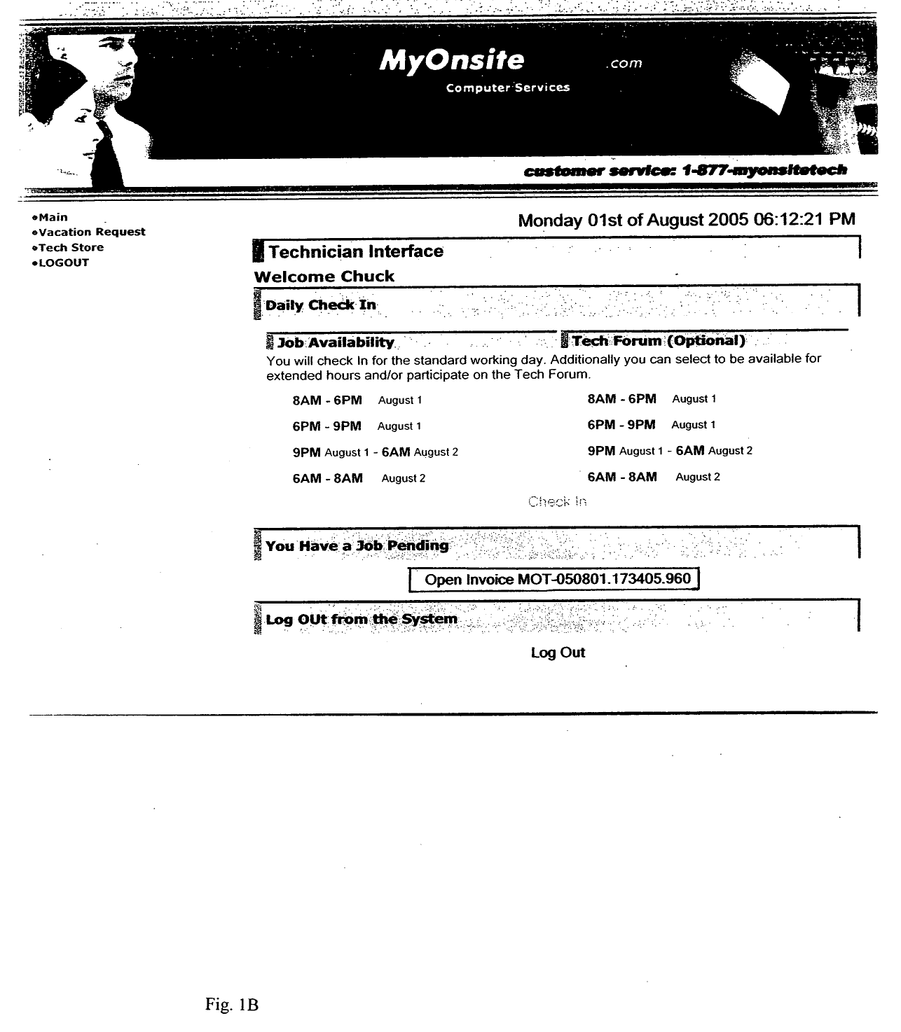

Shown in FIG. 1, is a flowchart depicting the preferred system and method for opening a client account, which creates a partial invoice for services to be accepted and completed by an available service providers. In the preferred system and method, a person in search of a computer repair technician (hereinafter referred to as a “client”) would begin by visiting a website that is designed to function as a user-friendly, online brokering-type service between clients and computer repair technicians. (1) Once the client has located the website, the client would enter information necessary to locate nearby, qualified repair technicians, such as the client's zip code, time zone, and the type of incident (i.e. business or residential related). (2)

During the next step of the preferred system and method, the computer will process the information entered by the client and retrieve longitude and latitude coordinates (3) corresponding to the zip code from a database of zip codes. (4) If the zip code is invalid, the computer will prompt the user to enter another zip code and the process will repeat itself. (5) Once a valid zip code has been entered, the computer will sort through the registered technicians and calculate the distance between the client's zip code and each technician's zip code based on the longitude and latitude to locate nearby technicians. (6) If there are no technicians available, the system will notify the client and present a Request for Service in the area. (7)

In the preferred system and method, if technician(s) are available, the computer will then display a listing of available technicians in the area (8) and may also display additional technician information, such as the technician's exact distance from the client, (9) the technician's resume and certifications, (10) and the types of incidents the technician is qualified to handle (11), as shown in greater detail in FIG. 1A. As shown in FIG. 1B, technicians will have logged onto the website the night before or in the morning, which signals to the computer that those technicians are available to work that day and will exclude non-available technicians from the listing that are included in the database. The system will also track and continuously update the availability of technicians. When a technician accepts an invoice, the system will update the list of available technicians to exclude those technicians who are logged onto the system as working on that particular day bit are currently occupied with another job. The information relating to the unavailable technicians will appear grayed out and may not be selected by the client. This is a particularly useful feature because it assists in ensuring the client's time is not wasted on requesting technicians who are not available.

The client then selects a technician from the listing of available technicians. (12) In the preferred method, the client would select the technician based on three choices, namely whether the computers to be serviced are networked or non-networked computers, (13) the estimated number of computers to be serviced, (14) and the time the service call is needed. (15) Thereafter, the client would accept the terms and conditions of service. (16)

After accepting the terms and conditions of service, the client would enter client information, such as contact information, the number of computers to be serviced, and the PC and Network configuration. (17) In the preferred system and method, the online client information form would require the user to enter an e-mail address where a user name and password would be sent. The user name and password will allow the client to view the electronic invoice live and give the technician permission to add more time and parts when necessary; the importance of this feature will become more apparent as the electronic invoice is described in more detail later in this detailed description.

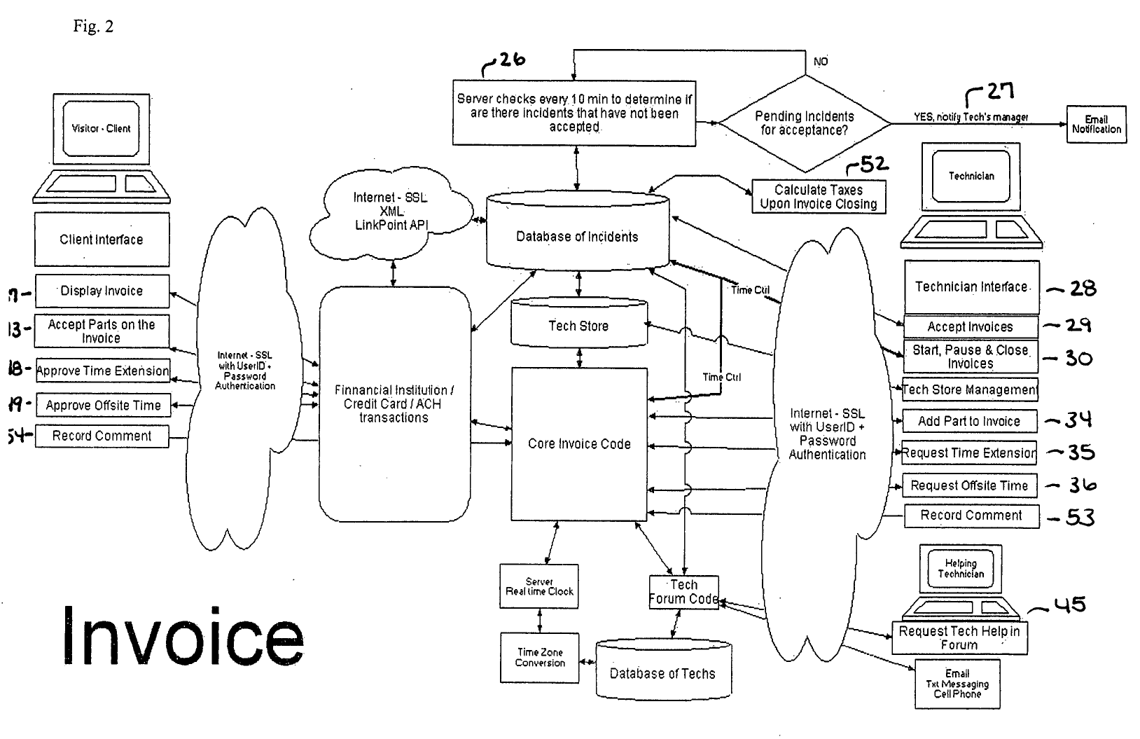

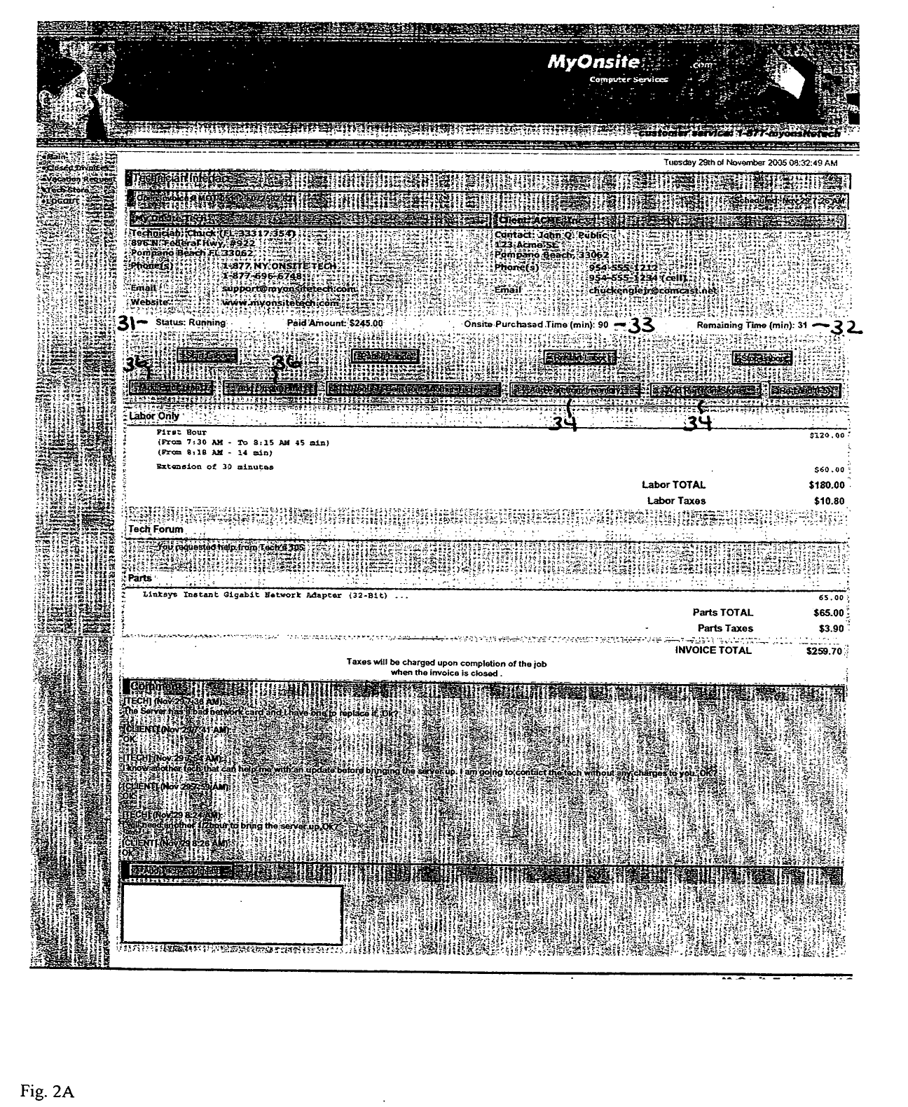

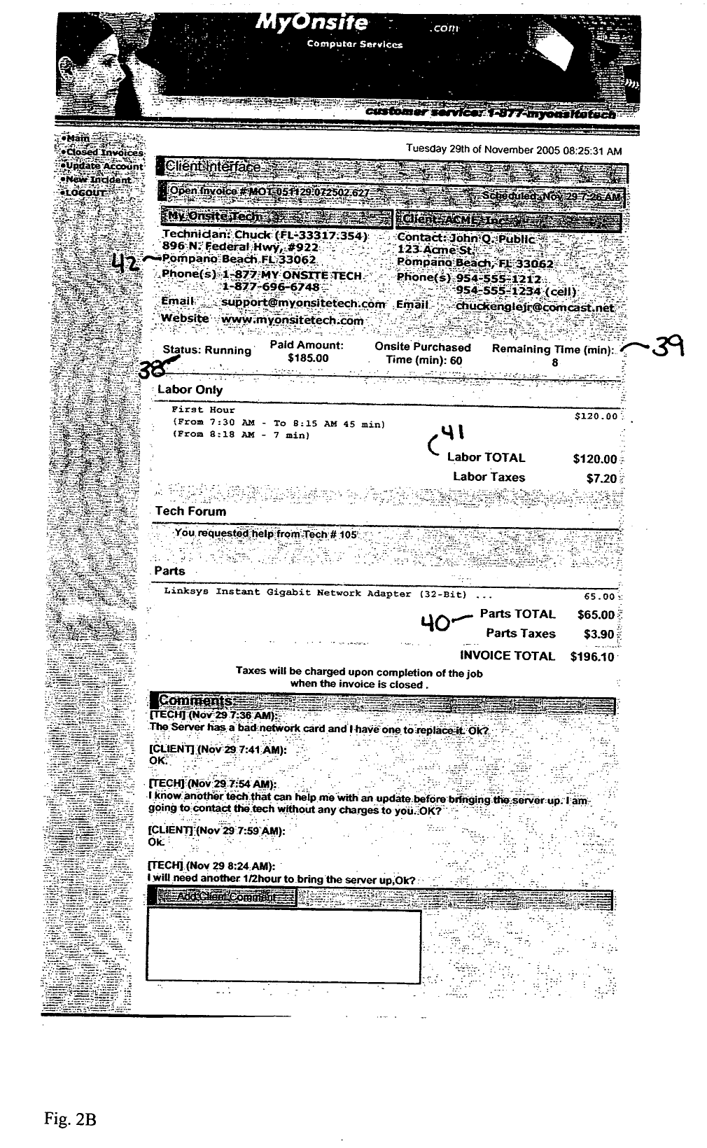

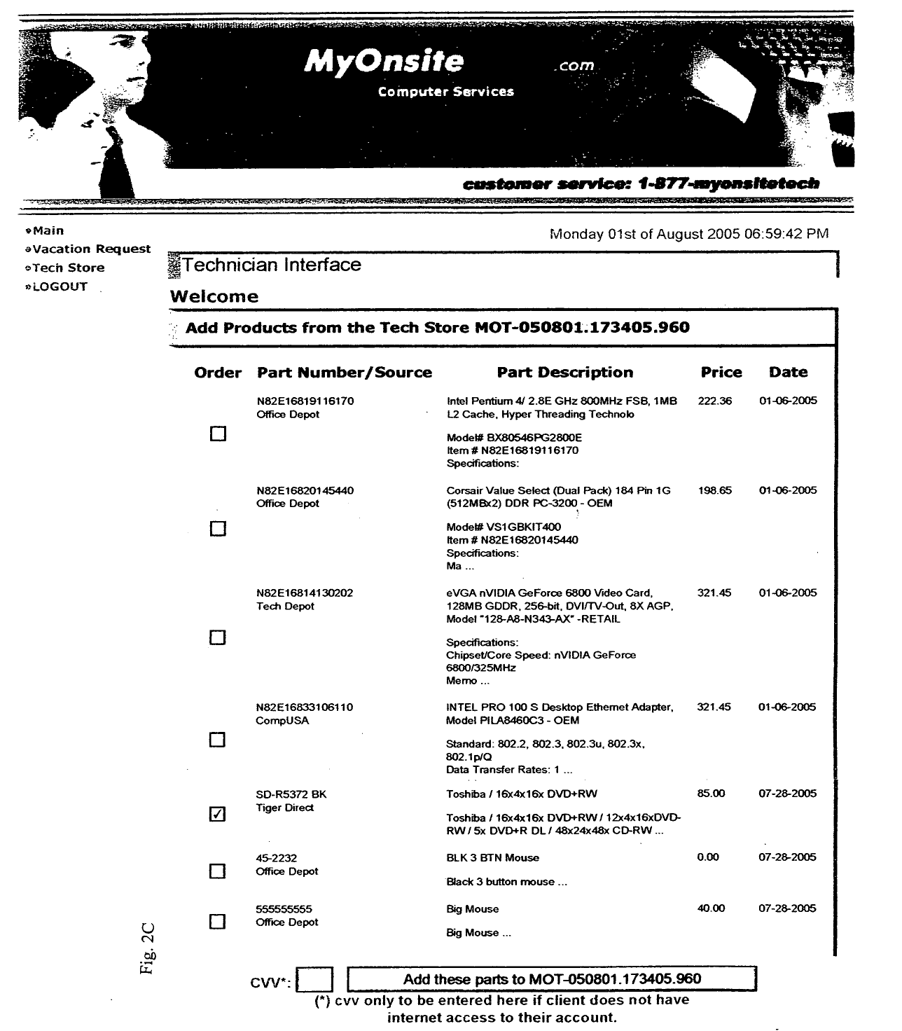

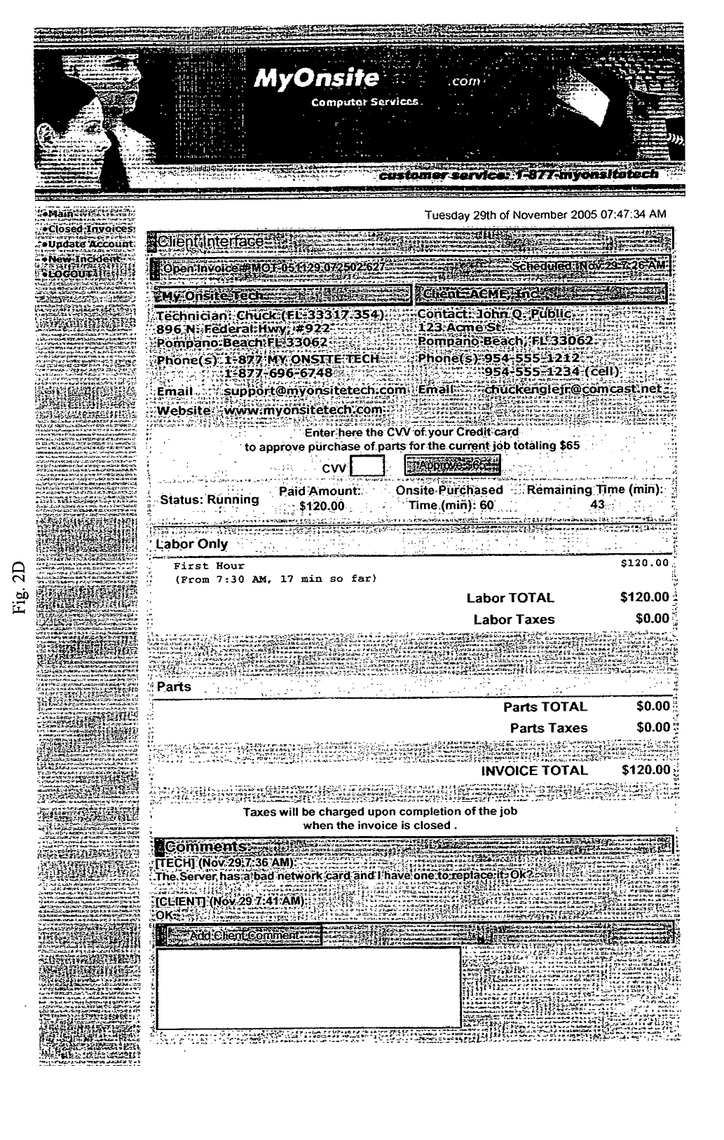

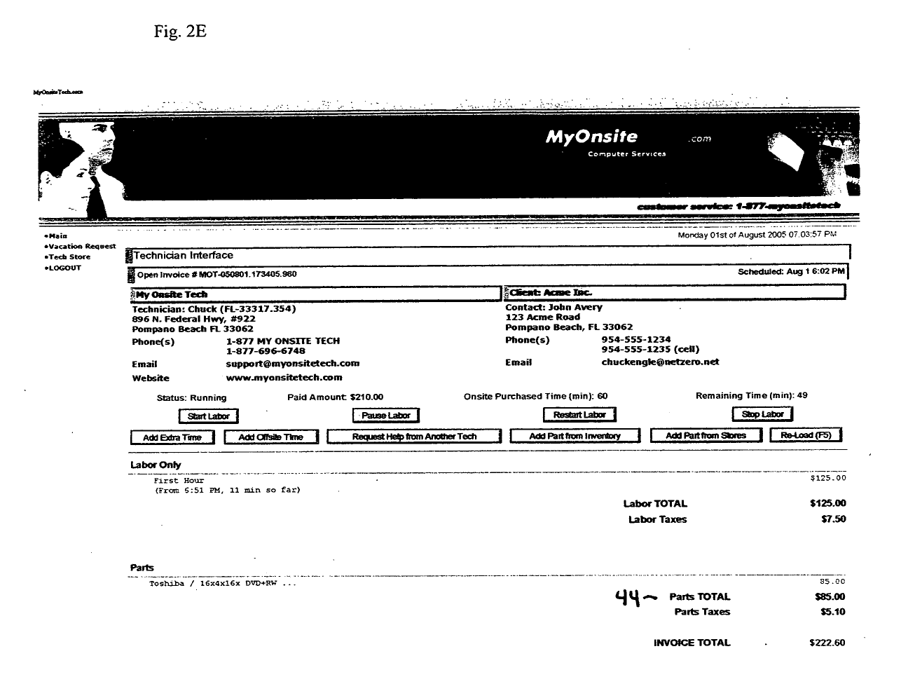

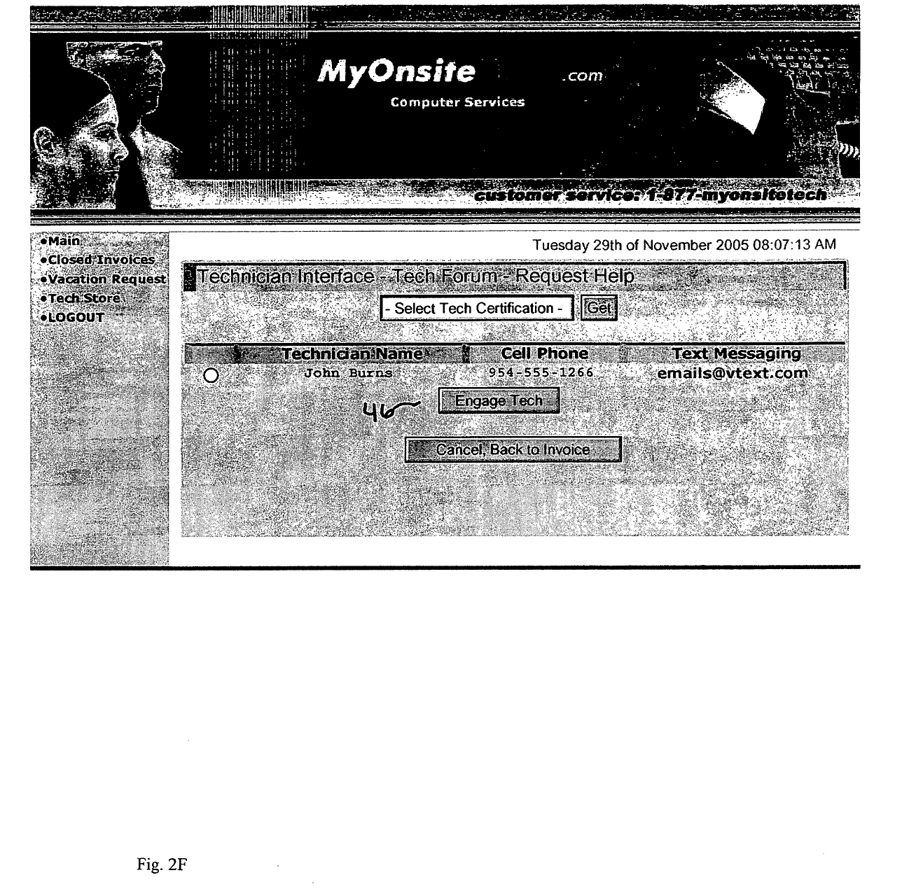

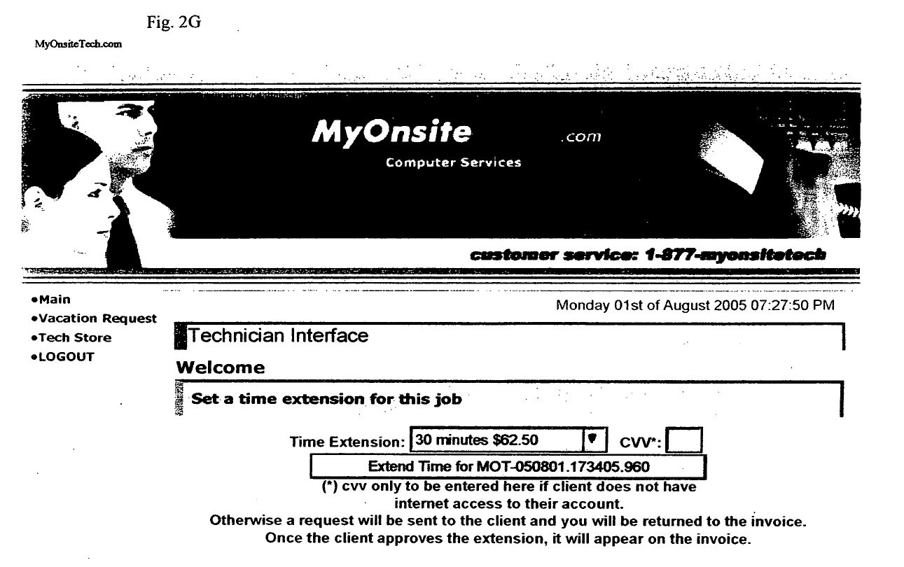

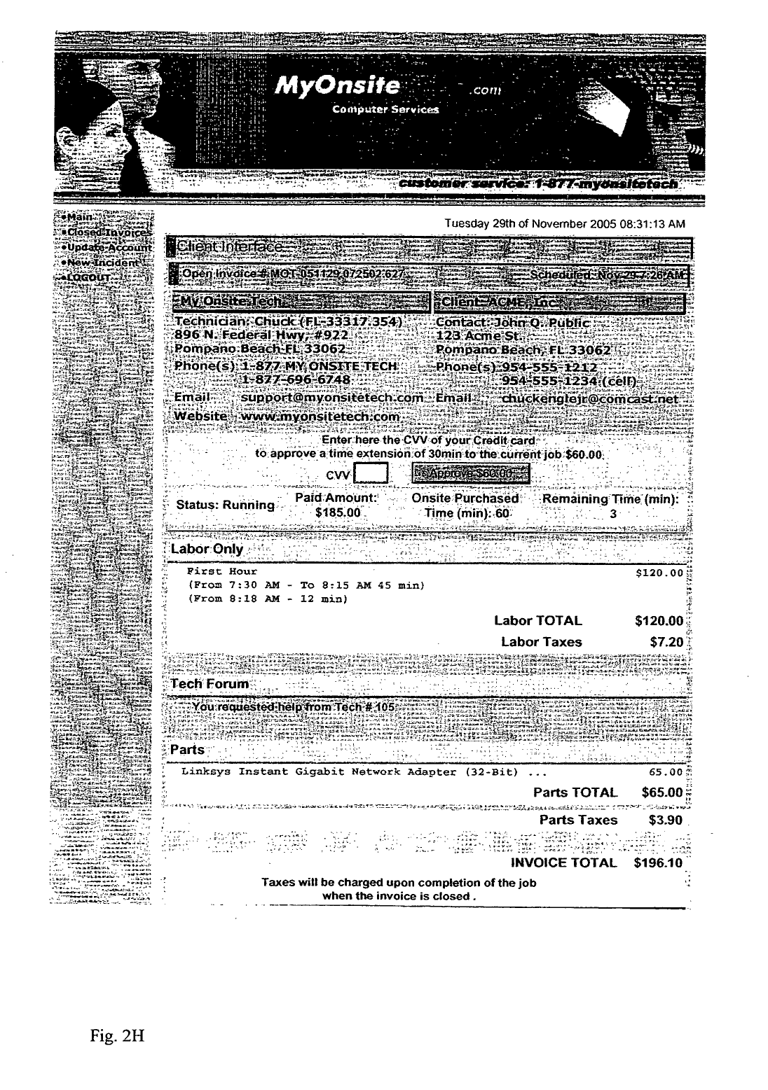

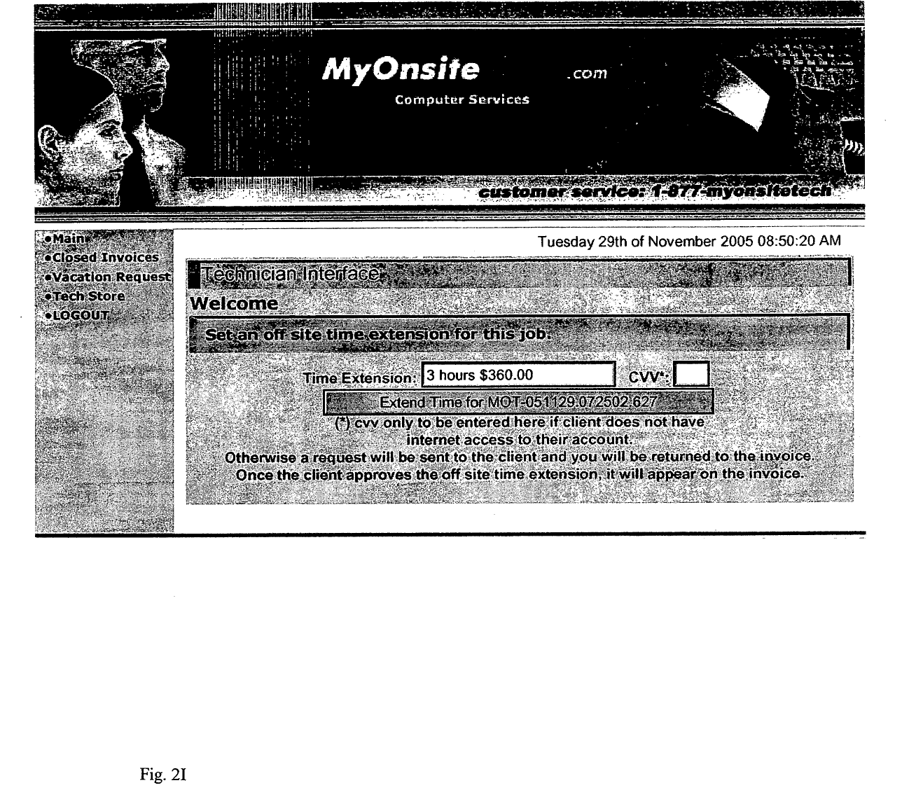

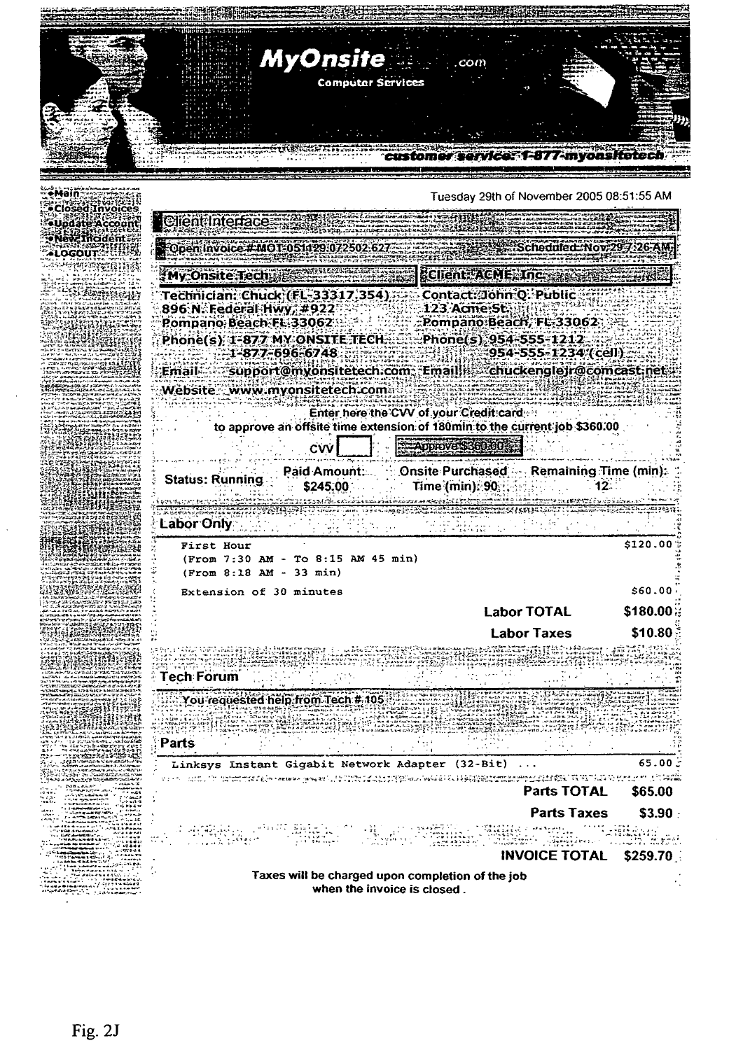

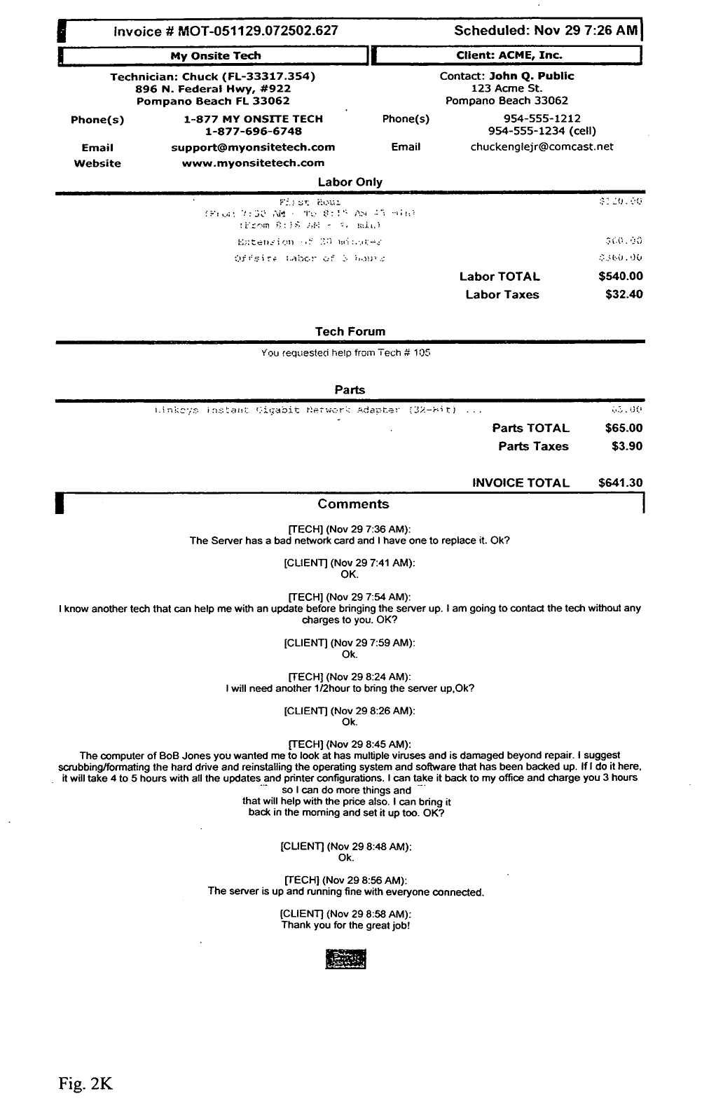

After the client information has been submitted, the client selects a payment option, such as credit card, debit card, wire transfer or electronic checking and enters the payment information. (18) Once payment is approved, (19) the client information, incident and payment information are written to a database. (20) A request is placed for a third party tax rate provider (50) to provide tax rates for labor and parts based on the zip code entered to select a technician (51). These rates are written to the database along with the client, incident, and payment information (20) and are to be used upon closing the invoice for calculating taxes due, as shown in FIG. 2 reference point (52). Referring again to FIG. 1, the client may write a detailed incident report, (21) which is then updated to the system. Thereafter, a notification is sent to the technician informing the technician of the service request. (22) In the preferred method, the notification would be sent in a text message (23) to the technician's cell phone (24) that would allow the technician to be notified immediately or a similar method, such as e-mail. (25) The technician would then telephone the client to arrange the service.

Turning now to FIG. 2 of the preferred method, the computer's server would also include an internal clock that would begin to run once the notification was sent to the technician. (26) The internal clock would be set to alert the website manager or administrator after a specified period of time, for example 10 minutes, if the technician does not log onto the website to accept the service request and set up an electronic invoice for the job. (27) This feature is particularly useful in an online environment where ensuring customer satisfaction is more difficult since there is little or no human interaction by allowing the website operator to oversee and make certain that services requests are not left unanswered.

Once the technician has received the text message or other form of immediate notification and agrees to accept the service request after speaking with the client, the technician logs onto the website's technician interface (28) and accepts the pending job invoice. (29) In the preferred method, the invoice would be divided into two parts; one part for labor and the other part for parts, namely for tax purposes. The technician starts the invoice and the time on the invoice begins to run in real time as the technician performs the work. (30) The technician may pause or stop the invoice in the event the technician needs to take a non-billable break. (30) As depicted in greater detail in FIG. 2A, the invoice reflect that the technician is working by the “running” status on the invoice. (31). The “remaining time” (32) continues to count down in real time until the amount of “purchased time” (33) is used. The technician may also add parts to the invoice, (34) request additional time from the client, (35) and request offsite time at an amount of time negotiated between the technician and the client. (36) In the preferred method, the technician interface would also include an online, technician store where the technician can select and add parts to be ordered to the invoice for acceptance by the client. (34)

The invoice has several unique and novel features that allow the client to view the invoice in real time from a remote location as the work is being performed. As mentioned earlier, the preferred method requires that the client provide an e-mail address on the customer information form to obtain a user name and password. Now that the online electronic invoice has been created, e-mail is sent to the client with a username and password allowing the client access to track the progress of the work by viewing the active invoice in real time. In the preferred method, the client logs onto the website's client interface and opens the invoice in progress. (37) As shown in greater detail in FIG. 2B, the invoice allows the client to view whether the technician is working on the incident, (38) how much time has been used and/or remains unused, (39) the invoice total for parts (40) and labor, (41) and the technician's contact information in the event the client wishes to contact the technician. (42)

If additional parts are necessary, the technician may select and add additional parts from the online tech store to the invoice, as shown in FIG. 2C. Once the parts are added to the invoice by the technician, an e-mail notification will be sent to the client requesting that the client log onto the website using his or her user name and password and approve the purchase of additional parts. Once the client is logged onto the website, he or she will view the client interface invoice to approve the addition or parts and input additional payment information. (43) The client interface invoice and the technician interface invoice are not identical in all respects. In this instance, the client interface invoice will have payment options, such as those shown in FIG. 2D. The technician's invoice will never show the client's payment methods to prevent fraud. As shown in FIG. 2E, the technician's invoice reflects the approval and payment of parts (44) but does not show the payment method.

An additional feature of the technician interface is the technician forum. (45) This feature allows the technician to request help from other technicians when the technician is experiencing problems he or she cannot solve. The technician may pause the invoice so that the client is not charged while the technician is requesting assistance. The technician may select a helping technician by certifications or other qualifications. Similar to the client interface, the listing of helping technicians will only show available technicians who are logged onto the system and who are not currently working on other service requests. Once the technician locates a helping technician, the technician may call the helping technician to discuss the matter and to determine whether the helping technician would agree to assist. Another unique feature of the system allows the helping technician to join on the invoice and share the fees for helping the technician in need of assistance, as shown in FIG. 2F by selecting the “engage tech” option. (46) In the preferred method, the client interface invoice will also reflect that a helping technician has joined the service request to keep the client informed of the service status.

In addition to requesting approval for parts, the electronic invoice allows a technician to request additional time to complete the service request. (35) In the preferred method, the invoice would automatically be set at a minimum hourly charge for undertaking the service request, for example one hour. (33) The invoice's real time timer would count down the hour until the hour is used or the technician stops the timer. (32) If it appears the request will take longer to complete, the technician may select additional time to be added to the invoice, as shown in FIG. 2G. Similar to the addition of parts, an e-mail notification will be sent to the client requesting that the client log onto the website using his or her user name and password, open the invoice, approve the addition of time, (48) and enter additional payment information, as shown in FIG. 2H. At anytime, if the client is already logged onto the website, he or she may simply refresh the browser to view the technician's requested additions to the invoice. The technician's invoice will update to show the client's approval of the additional time; however, the technician's invoice will not reflect the client's payment information. At any time before the invoice is closed, the technician and client may also engage in a real-time chat, which is reflected on the invoice, as shown in FIG. 2K. Referring back to FIG. 2, the invoice will record and reflect the comments entered by the technician (53) and the client (54).

The preferred system and method also includes an offsite time option on the invoice, as shown in FIG. 2I. This feature is particularly useful in situations where fixing the incident is time-consuming and does not require the technician's constant attention, such as scrubbing a computer and reinstalling software. This feature allows the client and technician an opportunity to barter for a lower price or flat fee in exchange for allowing the technician to take the computer offsite to complete at night and take other service requests during normal business hours. Similar to requesting additional parts and time, an e-mail notification will be sent to the client requesting that the client log onto the website using his or her user name and password, open the invoice, approve the addition of offsite time, (49) and enter additional payment information, as shown in FIG. 2J.

In the preferred method, once the service request is finished, the invoice is closed and the payment is held by the website operator for a period of time to allow resolution of any disputes before payment is made to the technician.

What is claimed is:

1. An electronic service procurement and invoicing system,
said system comprising:
a continuously updating database of available service providers;
an electronic invoice generated from a request for services received from a client;
software for routing the invoice to at least one service provider for the purpose of accepting the invoice; and
payment options to compensate the service provider who accepted the invoice upon satisfactory completion of the service request.

2. An electronic service procurement and invoicing system as described in claim 1 wherein the system comprises a counter that begins to run when the request for service is sent to the service provider.

3. An electronic service procurement and invoicing system as described in claim 2 wherein the system alerts a person when a service request has not been accepted within a predetermined period of time.

4. An electronic service procurement and invoicing system as described in claim 1 wherein the database appears shaded over service providers who are unavailable.

5. An electronic invoice, said invoice comprising:
an initial amount of time authorized for completing a service request;
an integrated counter that deducts the authorized time as the invoice is running.

6. An electronic invoice as described in claim 5 wherein said invoice further comprises client contact information.

7. An electronic invoice as described in claim 5 wherein said invoice further comprises service provider contact information.

8. An electronic invoice as described in claim 5 wherein said invoice further comprises an option to start the invoice running.

9. An electronic invoice as described in claim 5 wherein said invoice further comprises an option to pause the invoice.

10. An electronic invoice as described in claim 5 wherein said invoice further comprises an option to stop the invoice.

11. An electronic invoice as described in claim 5 wherein said invoice further comprises an option to request additional time to complete the service request.

12. An electronic invoice as described in claim 5 wherein said invoice further comprises an option to accept the request for additional time to complete the service request.

13. An electronic invoice as described in claim 12 wherein said invoice further comprises an option to provide payment for the additional time to complete the service request.

14. An electronic invoice as described in claim 5 wherein said invoice further comprises an option to add parts to the invoice.

15. An electronic invoice as described in claim 5 wherein said invoice further comprises an option to accept the addition of parts to the invoice.

16. An electronic invoice as described in claim 15 wherein said invoice further comprises an option to provide payment for the additional parts.

17. An electronic invoice as described in claim 5 wherein said invoice further comprises an option to request additional off site time to complete the service request.

18. An electronic invoice as described in claim 5 wherein said invoice further comprises an option to accept the addition of offsite time to complete the service request.

19. An electronic invoice as described in claim 18 wherein said invoice further comprises an option to provide payment for additional offsite time to complete the service request.

20. An electronic invoice as described in claim 5 wherein said invoice further comprises an option to request help from another service provider.

21. An electronic invoice as described in claim 5 wherein the invoice records real-time correspondence between the service provider and client.

22. An electronic invoice as described in claim 5 wherein the invoice total for labor and the total for parts are separate for tax purposes.

23. An electronic invoice as described in claim 5 further comprising taxable rate information for parts and labor acquired from a database at the time the invoice is closed.
